(19) United States
(12) Patent Application Publication
(10) Pub. No.: US 2025/0013422 A1
(43) Pub. Date: Jan. 9, 2025

(54) METHOD AND SYSTEM FOR A PERSONALIZED VEHICLE INTERACTIVE MUSIC SYSTEM

(71) Applicant: Ford Global Technologies, LLC, Dearborn, MI (US)

(72) Inventors: Bhagyashri Satyabodha Katti, Novi, MI (US); Nikhitha Bekkanti, Canton, MI (US); Kalyani Purushottam Sonawane, Plymouth, MI (US); Fling Tseng, Ann Arbor, MI (US); Himanshu Verma, Farmington Hills, MI (US); Kwaku O. Prakah-Asante, Commerce Twp., MI (US)

(21) Appl. No.: 18/348,812

(22) Filed: Jul. 7, 2023

(51) Int. Cl. G06F 3/16; B60Q 9/00; G10H 1/36; G10L 25/51

(52) U.S. Cl. CPC G06F 3/165; B60Q 9/00; G10H 1/361; G10L 25/51; G10H 2210/005; G10H 2220/011

(57) ABSTRACT

A method for providing an interactive music system in a vehicle includes estimating a travel time of the vehicle based at least on a learned travel behavior of a user of the vehicle; obtaining data related to at least one drive condition; detecting that the travel time of the vehicle is within a duration threshold and that the at least one drive condition is satisfied; defining a playlist based at least on the travel time in response to the travel time being with the duration threshold and the at least one drive condition being satisfied; and causing a sound to be emitted based on an audio signal indicative of a song from the playlist in an interactive mode using one or more speakers in the vehicle.

### TECHNICAL FIELD

The present disclosure relates to a vehicle entertainment system and more particularly, to an interactive music feature for a vehicle entertainment system.

### BACKGROUND

The statements in this section merely provide background information related to the present disclosure and may not constitute prior art.

Advancements in vehicular technology not only includes improving a user's drive experience but also includes providing an overall entertaining and convenient user experience in which the user can stay engaged while driving. For example, infotainment systems can allow a user to listen to personalized audio including music, podcasts, and talk radio shows.

### SUMMARY

This section provides a general summary of the disclosure and is not a comprehensive disclosure of its full scope or all of its features.

In one form, the present disclosure is directed to a method for providing an interactive music system in a vehicle. The method includes estimating a travel time of the vehicle based at least on a learned travel behavior of a user of the vehicle; obtaining data related to at least one drive condition; detecting that the travel time of the vehicle is within a duration threshold and that the at least one drive condition is satisfied; defining a playlist based at least on the travel time in response to the travel time being with the duration threshold and the at least one drive condition being satisfied; and causing a sound to be emitted based on an audio signal indicative of a song from the playlist in an interactive mode using one or more speakers in the vehicle.

In one form, the present disclosure is directed to a vehicle infotainment system. The system includes one or more computing devices of a vehicle that are configured to: estimate a travel time of the vehicle based at least on a learned travel behavior of a user of the vehicle; obtain data related to at least one drive condition; detect that the travel time of the vehicle is within a duration threshold and that the at least one drive condition is satisfied; define a playlist based at least on the travel time in response to the travel time being with the duration threshold and the at least one drive condition being satisfied; and cause a sound to be emitted based on an audio signal indicative of a song from the playlist in an interactive mode using one or more speakers in the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a vehicle having an interactive music system in accordance with the present disclosure;

FIG. 2 is a block diagram of the interactive music system of FIG. 1 in accordance with the present disclosure; and

FIG. 3 is a flowchart of an example interactive music routine in accordance with the present disclosure.

### DETAILED DESCRIPTION

As required, detailed embodiments are disclosed herein; however, it is to be understood that the disclosed embodiments are merely exemplary that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In providing an engaging experience, a vehicle infotainment system of the present disclosure provides an interactive music system (i.e., a karaoke system) in which a user is presented with a customized playlist of songs to sing along to. More particularly, when the vehicle is in a park state, the interactive music system may freely permit use of an interactive mode, however, in a moving state, the interactive music system analyzes various travel conditions as part of a contextual evaluation to assess whether the interactive mode may be employed. With interactive mode enabled, the user is presented with a personalized playlist that accommodates a travel time of the vehicle and is based on learned preferences of the user.

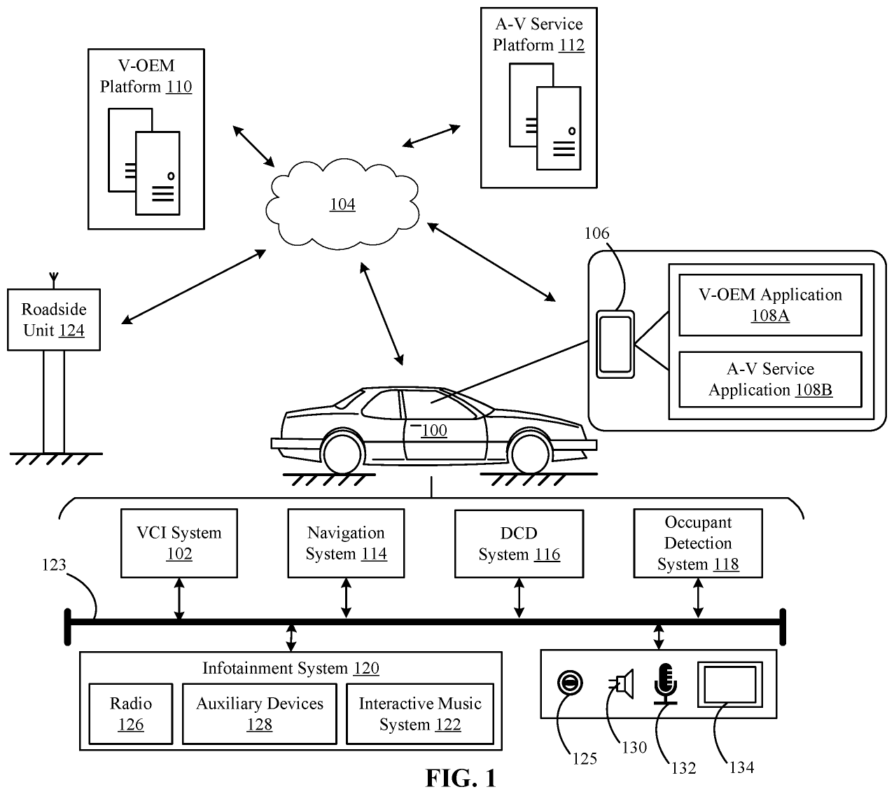

Referring to FIG. 1, a vehicle 100 is configured to communicate with various external devices/systems employing systems integrated in the vehicle 100 and devices brought and are in communication with the vehicle 100. Specifically, in one form, the vehicle 100 includes a vehicle communication interface (VCI) system 102 configured to communicate with external systems via one or more wireless communication networks 104. In a non-limiting example, the wireless communication networks 104 may be established via a cellular, WI-FI, BLUETOOTH, and/or broad-band communication. Accordingly, the VCI system 102 may include hardware components (e.g., computing device, routers, transceivers, modems, antennas, etc.) and are configured to operate via one or more software protocols executable by the computing device.

In another example, users or, in other words, passengers of the vehicle 100, may bring in a portable computing device 106 having wireless communication capabilities, such as tablets, cellular phones, smart watches, among others. The portable computing device 106 may communicate with the VCI system 102 via wireless communication (e.g., BLUETOOTH, WI-FI, cellular) and/or wired communication by connecting to an auxiliary port in the vehicle 100, such as a Universal Serial Bus (USB) port.

In some applications, the portable computing device 106 is operable to provide the vehicle 100 access to various services/tools via one or more software applications stored and executed therein. In a non-limiting example, software applications include a vehicle original equipment manufacturer (V-OEM) application 108A and an audio-visual (A-V) service application 108B (collectively “software applications 108”). The V-OEM application 108A is configured to communicate with a V-OEM platform 110 that may be a cloud based server in communication with the portable computing device 106 via the network 104.

In one form, the V-OEM platform 110 is configured to store information related to the user of the vehicle 100, such as, but not limited to, vehicle identification information of the vehicle 100 associated with the user, usage and service history of the vehicle 100, and identification information of the user (e.g., name, contact information, picture of the user). The V-OEM platform 110 may further provide various convenient accessories such as, but not limited to, a music library of various songs available to the user via the V-OEM or second party platform. In addition to or in lieu of the portable computing device 106, the vehicle 100 may also include the V-OEM application 108A permitting the vehicle 100 to communicate with the V-OEM platform 110 directly via the VCI system 102.

The A-V service application 108B is an audio-visual entertainment service providing the user access to a library of A-V files such as, but not limited to, music, videos, and podcasts, among other A-V type files. In a non-limiting example, the A-V service application 108B is in communication with an A-V service platform 112 that is a cloud based server providing access to the library A-V files.

Among other systems, the vehicle 100 further includes a navigation system 114, a drive condition detection (DCD) system 116, an occupant detection system 118, and an infotainment system 120 having an interactive music system 122. Among other components, the navigation system 114, the drive condition detection system 116, the occupant detection system 118, and the infotainment system 120 include one or more computing devices for performing the functions described here. In addition, the VCI system 102, the navigation system 114, the drive condition detection system 116, the occupant detection system 118, and the infotainment system 120 are in communication via a vehicle network 123 (e.g., a controlled area network (CAN) or local interconnect network (LIN)).

In a non-limiting example, the navigation system 114 is configured to track a location of the vehicle 100, define a travel route based on a desired destination, provide directions to the desired destination based on the travel route defined, and estimate travel time of the vehicle 100 to the desired destination. In one form, the navigation system 114 includes a global navigation satellite system (GNSS), a map library, and/or navigation algorithms for defining the travel route.

The drive condition detection system 116 is configured to detect various drive conditions of the vehicle 100, such as, but not limited to: a road condition, traffic condition, and/or weather condition. As described herein, the drive conditions are employed to determine whether an interactive mode supported by the interactive music system 122 may be available to the user.

The road condition provides information related to whether a road is paved or unpaved, and may be provided by the navigation system 114. For example, the maps provided in the map library may indicate which roads are paved/unpaved, and once the travel route is defined or as the location of the vehicle 100 is being monitored, the navigation system 114 indicates whether the road being travelled on is paved or unpaved. In another example, images from cameras arranged to capture the external environment of the vehicle 100 may be analyzed to determine if the road conditions are paved or unpaved, which may be used with or without the information from the navigation system 114.

Information related to the traffic condition and/or weather condition may be provided by other vehicle(s) or a roadside unit 124 in communication with the vehicle 100. In a non-limiting implementation, the vehicle 100 may be configured to communicate via vehicle-to-vehicle (V2V) and vehicle-to-infrastructure (V2I), or more broadly, vehicle-to-everything (V2X) protocols. Under V2X protocol, the vehicle 100 exchanges vehicle drive information (e.g., time, a position of the vehicle 100, a moving speed, a heading of the vehicle, steering wheel angle, and/or break status of the vehicle) and traffic information (e.g., statues of traffic lights, reported traffic accidents, construction information) with, for example, the roadside unit 124.

In one form, the roadside unit 124 is configured to monitor traffic and environmental condition (e.g., weather) around an area of the roadside unit 124. The roadside unit 124 broadcasts messages including the traffic/environmental condition to V2I enabled vehicles. The roadside unit 124 may include one or more computing devices, sensors (e.g., weather sensors, object detection sensors such as, but not limited to, lidar, cameras, infrared sensors), and communication devices such as, but not limited to, antennas, transceivers, modems.

In addition to or in lieu of V2X based messages, the drive condition detection system 116 may receive information regarding the environmental conditions from sensors arranged about the vehicle 100, such as, temperature sensors, humidity sensors, among others. In yet another example, the drive condition detection system 116 may receive information regarding drive conditions from the navigation system 114. For instance, the navigation system 114 may provide data indicative of complex road topography such as lots of curves/turns, frequent signals, accident prone zone etc.

The occupant detection system 118 is configured to detect and monitor the user in a passenger cabin of the vehicle 100 using object detection sensors, such as but not limited to, one or more cameras 125 arranged in the vehicle 100. The cameras 125 may include a video camera (monochrome and/or color), infrared camera, and/or passive infrared sensor.

In one form, the occupant detection system 118 is configured to detect and identify occupants within the vehicle 100 using known image processing techniques. For example, the occupant detection system 118 obtain images of the passenger cabin and determines whether there is an occupant in the passenger cabin using an image processing software application. In a non-limiting example, the image processing software application includes facial detection algorithms to detect the occupant and obtain facial characteristics of the occupant. In some variations, the image processing software application may also be configured to determine if the occupant detected is a child or an adult, which may be further used to customize a playlist for the interactive mode.

In addition to or in lieu of images from the cameras 125, the occupant detection system 118 may be configured to detect an occupant in the vehicle 100 using audio signals from the microphone 132. In yet another example, the vehicle 100 may be equipped with occupant detection sensors in the seats (e.g., weight or pressure sensors) that may be used with or without the audio signals from the microphone 132 and/or the images from the cameras 125 to detect an occupant. Using known techniques, the data from the occupant detection sensors may be compared to different threshold to further determine if the occupant is an adult or child.

The infotainment system 120 is configured to provide information and access to various auxiliary features, such as, the navigation system 114, a radio 126, one or more auxiliary devices 128 if connected, and the interactive music system 122. In one form, the auxiliary devices 128 may include a storage medium for storing media files accessible by the infotainment system 120, such as, but not limited to, a USB drive (not shown) and/or a portable media player (not shown)).

The infotainment system 120 includes interface devices for interacting with the user, such as, audio devices (e.g., speaker 130 and/or microphone 132), display device 134 (e.g., a head-up display and/or a liquid crystal display with touchscreen), and/or other suitable input devices (e.g., buttons, knobs). For example, the user may communicate with a vehicle assistant via the audio device to access and control various auxiliary features like the interactive music system 122. In another example, the display device 134 may present various graphical user interfaces that may have selectable icons to control features of the vehicle 100.

As described herein, the interactive music system 122 provides a customizable karaoke experience via the interactive mode in which the user sings along to a song being played via the speaker 130. In a non-limiting example, the songs available for the interactive mode may be provided by the V-OEM application 108A, the A-V service application 108B, the radio 126, and/or the auxiliary devices 128, and may collectively be referred to as music platforms.

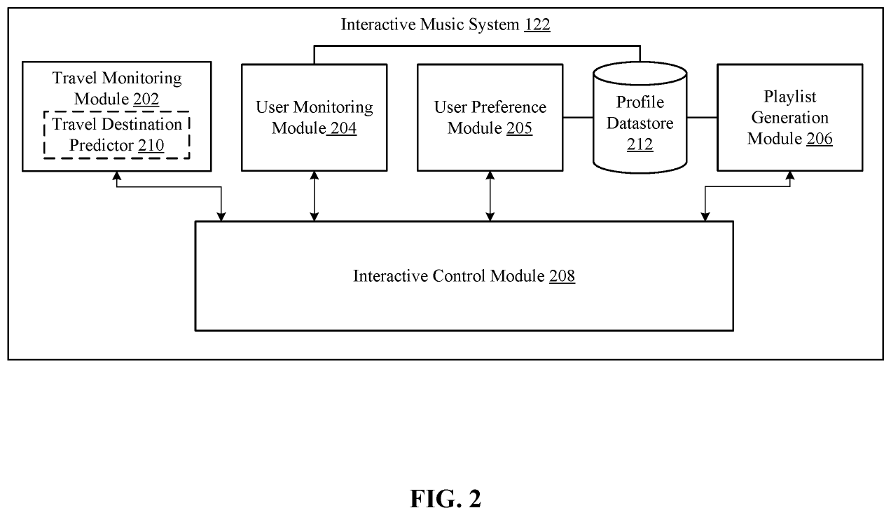

Referring to FIG. 2, the interactive music system 122 includes a travel monitoring module 202, a user monitoring module 204, a user preference module 205, a playlist generation module 206, and an interactive control module 208.

The travel monitoring module 202 is configured to obtain information regarding the travel time of the vehicle 100 and one or more of the drive conditions, which is provided to the interactive control module 208 to determine if the interactive control module 208 should be offered to the user. In one form, the travel time of the vehicle 100 may be provided by the navigation system 114 when the user provides a desired destination, and the one or more of the drive conditions, such as road condition, weather condition, and/or traffic condition, may be provided by the drive condition detection system 116.

In some variations, the travel time may be estimated based at least on a learned travel behavior of the user. In a non-limiting example, the travel monitoring module 202 is configured to store travel information regarding the user, who is detected by the occupant detection system 118 and identified by the user monitoring module 204, as described herein. Travel information for trips taken by the user may include: travel time, starting location of the vehicle 100 (e.g., location of the vehicle 100 when the vehicle 100 is turned on), destination of the vehicle 100 (e.g., location of the vehicle 100 when the vehicle 100 is turned off), and a travel time. Using machine learning techniques (e.g., cluster analysis, neural network, regression analysis), the travel monitoring module 202 is configured to define a travel destination predictor 210 that is configured to identify a potential destination of the user based on current travel state of the vehicle 100, which may include, but is not limited to: current time, current location of the vehicle 100, drive state (e.g., is vehicle 100 ON or OFF). Once the potential destination is identified, the travel monitoring module 202 is configured to estimate a travel route to the potential destination and a travel time based on a current location of the vehicle 100, a current time, and traffic information from the drive condition detection system 116.

In one form, the travel monitoring module 202 is configured to adjust the travel route and redetermine the potential destination as the vehicle 100 travels based on the location of the vehicle 100, which may be provided by the navigation system 114. For example, if the user travels home around 6:00 pm on Monday from a specific location (e.g., work), the travel monitoring module 202 may initially identify the home address as the potential destination. However, the vehicle 100 may begin to deviate from the travel route to the potential destination and the travel monitoring module 202 identifies another potential destination based on, for example, the current location and heading of the vehicle 100.

In an example implementation, features of the travel monitoring module 202 may be implemented outside of the vehicle 100. For example, the V-OEM platform 110 may be configured to learn the travel behavior or pattern of the user based on data from the navigation system 114 and provides the travel destination predictor 210 to the travel monitoring module 202.

The user monitoring module 204 is configured to identify the occupant of the vehicle 100, as a user, and detect if the user is singing. More particularly, in one example, if an occupant of the vehicle 100 is detected, the user monitoring module 204 is configured to identify the user based on facial characteristics from the occupant detection system 118, which may be compared to prestored data of previous users of the interactive music system 122. In another example, if the occupant is detected, the user monitoring module 204 is configured to use the interfaces (e.g., speaker 130, microphone 132, and/or display device 134) to obtain identification information from the user, such as a name. While specific examples are provided, the user monitoring module 204 may use other methods for identifying the occupant.

To detect whether the user is singing, the user monitoring module 204 is configured to monitor physical pose/movement of the user and/or audio data from the passenger. More specifically, in a non-limiting example, physical movement related to singing may include nodding, moving lips, snapping fingers, and/or clapping. Such movement indicates that the user is singing or in a mood to sing, and thus may be interested in the interactive mode. In an example implementation, the user monitoring module 204 is configured to identify movement of selected body parts of the user and interprets the identified body movement to a current state of mind of the user to recommend the interactive mode. In one form, the user monitoring module 204 is configured to receive data regarding a current pose, gesture, and/or movement of the user from the occupant detection system 118, and identifies predefined pose, gesture, and/or movements, which are associated with a selected state of mind of the user.

In lieu of or in addition to physical movement, the user monitoring module 204 may also use audio data detected by the microphone 132 to identify selected words or a tune using known speech recognition techniques. Accordingly, the user monitoring module 204 is able to detect whether the user is singing and may recommend to the interactive control module 208 that the interactive mode be offered.

In lieu of or in addition to detecting body movement of a specific user, the user monitoring module 204 is configured to detect selected events in the passenger cabin of the vehicle 100. That is, if multiple users are in the vehicle 100 including the driver, the user monitoring module 204 may be notified of the presence of the other occupants by the occupant detection system 118. Using data indicative of facial features of the other occupants and predefined correlation between facial features and mood, the user monitoring module 204 is configured to determine whether the interactive mode may be recommended. In a non-limiting example, if the users are moving their lips and/or the audio data indicates multiple voices, the user monitoring module 204 is configured to determine that the users are conversing and thus, no interactive mode is needed. Alternatively, if the passenger cabin is quiet and/or the other users appear to be sleeping, the user monitoring module 204 may recommend that the interactive control module 208 offer the interactive mode to occupy the other passengers.

While specific examples are provided, the user monitoring module 204 may be configured to monitor different movements of the user to determine whether the user may be interested in singing. In addition, the user monitoring module 204 may be configured to recommend the interactive mode based on other events in the vehicle 100. For example, if the user monitoring module 204 detects an infant sleeping in the passenger cabin, the user monitoring module 204 may not recommend the interactive mode to the interactive control module 208.

The user preference module 205 is configured to store information related to the user in a profile record stored in a profile datastore 212. The profile record may include identification information used to identify the user (e.g., user's name, data employed for facial recognition, and/or a vocal sample) and musical preference information indicating type of music the user prefers to listen to (e.g., artists, genre, and/or radio station settings). The identification information and/or the musical preference information may be added by the user during a profile creation process. After creating the profile, the user preference module 205 may continue to learn and store information related to the musical preference of the user. For example, when the occupant is identified as a user of the interactive music system 122, the user preference module 205 may obtain information related to the type of music being emitted and update the profile record associated with the user.

In some variations, the user preference module 205 is further configured to learn interactive habit or pattern of the user. In a non-limiting example, the user preference module 205 is configured to store information and further learn when the user employs the interactive mode. The information captured as part of the interactive pattern may include time of day the interactive mode is employed (i.e., a usage time), information related to other users/passengers in the vehicle 100, destinations being traveled when the interactive mode is employed, among other suitable information for identifying patterns. For example, a user may employ the interactive mode when traveling home on Fridays, but not on Mondays. In another example, the user may employ the interactive mode when they are alone in the vehicle 100, but not when other passengers are in the vehicle 100.

The playlist generation module 206 is configured to define a playlist based at least on the travel time. In a non-limiting example, the playlist generation module 206 is configured to access songs available for the interactive mode from the music platforms. Based on the duration of an available song and the travel time to the destination, the playlist generation module 206 selects from among the available songs to generate the playlist. The number of songs listed may be based on a total duration setting that can be provided by the user such that the total duration of the songs on the playlist is greater than the travel time or less than the travel time.

In a non-limiting example, a total duration of songs provided in the playlist is shorter than that of the travel time and is as close to the travel time without going over. Accordingly, if the travel time to the destination is 10 mins and the songs available include song-1 with a duration of 3 min 30 sec, song-2 with a duration of 4 mins 25 sec, and song-3 with a duration of 6 mins, the playlist generation module 206 generates a playlist with song-1 and song-3. Alternatively, if the playlist is to have enough songs to reach at least reach the destination, the playlist may include song-2 and song-3, or all three songs.

In some variations, the playlist generation module 206 is configured to adjust the playlist in response to the travel time changing. For example, if the travel time was originally 12 mins but is adjusted to 7 mins, the playlist generation module 206 may remove one or more songs from the playlist. Similarly, the playlist generation module 206 may add songs if the travel time increases.

In one form, the type of songs to be added to the playlist is defined based on a music preference profile associated with the user. More particularly, the playlist generation module 206 may access the profile datastore 212 to obtain information indicative of the preferred type of music the user listens to, and populates the playlist based on songs available on the music platforms that correlates with the preferred type of music. The information regarding the preferred type of music may identify specific artist, genre of music, and/or analogous artist, among other information used to identify preferences.

The interactive control module 208 is configured to determine whether to permit an interactive mode based at least on the travel information, and if permitted, have a song from the playlist be played in the vehicle 100. In the interactive mode, a sound is emitted based on an audio signal indicative of the song, and the audio signal may include an instrumental portion of the song, background vocals of the song, primary vocals of the song, or a combination thereof. In a non-limiting example, the interactive control module 208 is configured to process audio signals from music platform using an audio signal processing board (e.g., SHARC) to separate vocal portion from instrumental portion of a song. The audio signal processing board may be combined with machine learning models that would further remove the vocals with a fine output, and provide the instrumental portion of the song along with the lyrics to be displayed on screen if applicable. The audio signal processing board may also provide the vocal portion when requested.

In one form, to determine whether to provide the interactive mode, the interactive control module 208 is configured to detect whether a travel time of the vehicle is within a duration threshold and whether at least one drive condition is satisfied. With respect to the travel time, the interactive control module 208 determines whether the travel time of the vehicle 100 is greater than or equal to the duration threshold. In one example, the duration threshold is selected based on the duration of the shortest or alternatively, the longest song available for the interactive mode. In yet another example, the duration threshold may also be defined by the user and is a set value (e.g., 10 mins, 20 mins, etc.)

With respect to the drive condition, the interactive control module 208 is configured to determine if the environment about the vehicle 100 is appropriate for providing the interactive mode. In one example, the drive condition may be based on the road condition, and the interactive control module 208 may determine that the interactive mode is not appropriate when the road is unpaved since the user may focus on guiding the vehicle 100 thru the unpaved road.

In another example, the drive condition may be based on traffic conditions, and the interactive control module 208 may determine that the interactive mode is appropriate when traffic is moving at a set speed (i.e., freely moving) and is not appropriate when the traffic is slow or stopped. In addition, the interactive control module 208 may further determine that the interactive mode is not appropriate when the vehicle 100 is traveling through a construction zone.

In yet another example, the drive condition may be based on weather. In a non-limiting example, if there is no precipitation (e.g., snow, rain) and/or visibility range is acceptable (i.e., no fog or mist), the interactive control module 208 may permit the interactive mode.

In some implementations, the interactive control module 208 may provide access to the interactive mode when the travel time and all of the drive conditions are satisfied.

While specific examples of drive conditions and how the conditions are evaluated for determining whether to elect interactive mode are provided, other drive conditions and/or evaluations may be employed. For example, the drive condition may include a drive mode of the vehicle 100, which may include park, reverse, neutral, automatic drive, manual drive, all-wheel drive, four-wheel drive, and/or off-road. The interactive control module 208 may provide access to the interactive mode without evaluating the travel time and/or other drive conditions when the vehicle 100 is in a park mode. In another example, the interactive control module 208 may not provide access to the interactive mode when the vehicle 100 is in an off-road state.

In some variations, in addition to travel conditions, the interactive control module 208 determines whether to permit the interactive mode based on a recommendation from the user monitoring module 204 and/or a preference of the user from the user preference module 205 (e.g., the interactive control module 208 determines whether the user uses the interactive mode at the current time/day based on the profile record of the user). For example, if the travel condition(s) is met, the interactive control module 208 may still not permit the interactive mode if the user monitoring module 204 indicates not to (e.g., no recommendation because infant is sleeping, or user is not singing). In yet another example, if the travel condition(s) is met, the interactive control module 208 may permit the interactive mode if the user typically employs the interactive mode under same conditions as determined by the user preference module 205.

When at least one or more of the travel conditions are met, the interactive control module 208 initiates interactive mode based on physical movement of the user. In a non-limiting example, if the user monitoring module 204 detects the user is singing as discussed above, the interactive control module 208 may activate the interactive control module 208 and provide an audio signal with the instrumental portion of the song being played in the vehicle 100.

In addition to or in lieu of detecting the physical movement of the user, the interactive control module 208 presents the interactive mode as a selectable feature via the interface. For example, one or more icons may be displayed on the display device 134, a discrete button in the passenger cabin and associated with the interactive mode may be illuminated, the vehicle assistant may inform the user that the interactive mode is available via the speaker 130 and whether the user would like to activate it.

In a non-limiting example, the interactive control module 208 is configured to activate the interactive mode and provide selectable features using one or more interfaces (e.g., speaker 130, microphone 132, and/or display device 134). The selectable features may include, but are not limited to: activating/deactivating the interactive mode when available; an interactive level in which the user is able to select whether the song being played includes instrumental portion of the song, vocals of the song, or a combination thereof; a duet feature (described below); and/or a song selection feature in which the playlist is provided to the user.

In some variations, for the interactive level, the user is able to toggle between the different levels via input interface. For example, a button may be provided at a steering wheel or other suitable location for toggling between the different interactive levels such that interactive control module 208 plays the song with the instrumental portion first and when the button is pressed the vocal portion is provided. When the button is pressed again, the vocal portion is removed. This allows the user to initiate a vocal support request via the button, thereby customizing the interactive experience.

In some variations, the interactive control module 208, may display lyrics of the song on the display device 134 of the vehicle 100.

In some variations, the interactive control module 208 is configured provide a duet feature in which vocal support is provided to the user. Specifically, during the interactive mode, the interactive control module 208 detects whether the user is singing with the song via the user monitoring module 204, and provides the audio signal with a vocal portion of the song in response to the user not singing with the song; and provides the audio signal without the vocal portion of the song in response to the user singing with the song. The vocal portion not being sung may be the original vocal portion from the song and/or may be a digital voice created by the interactive control module 208 based on the lyrics.

In an example scenario, with the duet feature active, the interactive music system 122 is configured to act as a partner to sing along with the user. Accordingly, the user may sing verses associated with a first voice/singer and the interactive music system 122 may provide vocal sound for verses associated a second voice/singer. Thus, once the verse for the second voice is over, the vocal sound is stopped to allow the user to sing the verse associated with the first voice.

In one example implementation, the duet feature may be automatically provided by the interactive control module 208 and may be turned off by the user via the interface (e.g., a verbal command and/or a button on the display device 134).

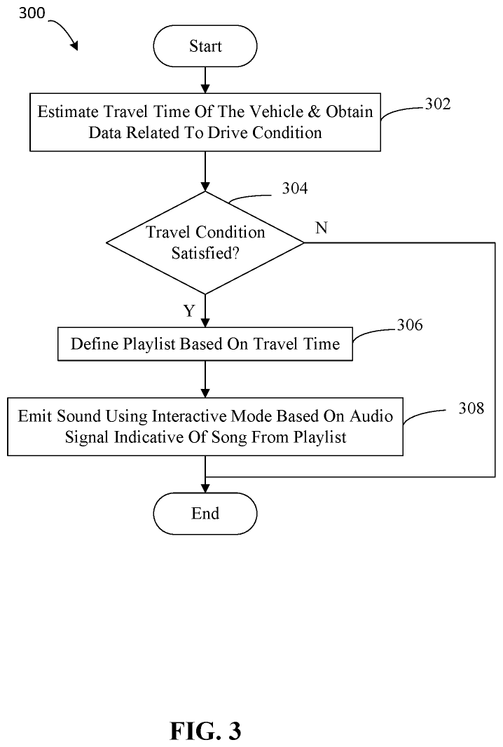

Referring to FIG. 3, an example interactive music routine 300 is provided and is executable by the infotainment system 120 having the interactive music system 122 of the present disclosure. Additional details regarding the various operations of the routine 300 are provided above.

At operation 302, a travel time of the vehicle 100 is estimated and data related to drive condition is obtained. In one form, the travel time may be estimated based at least on a learned travel behavior of the user of the vehicle 100 and the drive condition may include road condition, traffic condition, and/or weather condition. At operation 304, the system 120 determines if the travel condition(s) is satisfied. For example, the system 120 determines if the travel time of the vehicle 100 is within a duration threshold and at least one drive condition is satisfied.

If the travel condition is satisfied, the system 120 defines a playlist based at least on the travel time, at operation 306. Using the speaker 130, at operation 308, a sound is emitted using the interactive mode based on an audio signal indicative of a song from the playlist.

The infotainment system 120 having the interactive music system 122 may be configured in various suitable ways, and is limited to the routine 300 of FIG. 3. In a non-limiting example, a routine may include operations for identifying the user and defining the playlist based on a profile record associated with the user. In another example, a routine may detect if the user is singing to determine if the interactive mode is to be provided for emitting the song.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip. The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure

What is claimed is:

1. A method for providing an interactive music system in a vehicle, comprising:
estimating a travel time of the vehicle based at least on a learned travel behavior of a user of the vehicle;
obtaining data related to at least one drive condition;
detecting that the travel time of the vehicle is within a duration threshold and that the at least one drive condition is satisfied;
defining a playlist based at least on the travel time in response to the travel time being with the duration threshold and the at least one drive condition being satisfied; and
causing a sound to be emitted based on an audio signal indicative of a song from the playlist in an interactive mode using one or more speakers in the vehicle.

2. The method of claim 1, wherein the estimating the travel time of the vehicle further comprises:
obtaining data indicative of a current travel state of at least one of the vehicle or the user; and
identifying a potential destination of the user based on the current travel state and a travel destination predictor defined based on previous destinations traveled by the user, wherein the travel time is estimated based on the potential destination.

3. The method of claim 1, wherein the at least one drive condition includes at least one of a road condition, a traffic condition, or a weather condition.

4. The method of claim 3, wherein:
the at least one drive condition includes each of the road condition, the traffic condition, and the weather condition, and
each of the at least one drive condition is to be satisfied prior to providing the interactive mode.

5. The method of claim 1, further comprising:
monitoring the travel time to a destination after defining the playlist; and
adjusting the playlist in response to the travel time changing.

6. The method of claim 1, wherein in the interactive mode, the audio signal is indicative of instrumental portion of the song.

7. The method of claim 1, wherein in the interactive mode, the method further includes displaying lyrics of the song on a display of the vehicle.

8. The method of claim 1, further comprising detecting and identifying an occupant in the vehicle, wherein the identified occupant is the user, and wherein the playlist is defined based on a music preference profile associated with the user.

9. The method of claim 1, further comprising:
obtaining a profile record associated with the user, wherein the profile record includes information related to a usage time when the interactive mode is employed,
wherein the playlist is further defined in response to a current time correlating with the usage time.

10. The method of claim 1, further comprising, in the interactive mode:
providing the audio signal with a vocal portion of the song in response to receiving a vocal support request; and
providing the audio signal with instrumental portion of the song absent the vocal support request.

11. The method of claim 1, further comprising, in the interactive mode:
detecting whether the user is singing with the song;
providing the audio signal with a vocal portion of the song in response to the user not singing with the song; and
providing the audio signal without the vocal portion of the song in response to the user singing with the song.

12. A vehicle infotainment system, comprising:
one or more computing devices of a vehicle configured to:
estimate a travel time of the vehicle based at least on a learned travel behavior of a user of the vehicle;
obtain data related to at least one drive condition;
detect that the travel time of the vehicle is within a duration threshold and that the at least one drive condition is satisfied;
define a playlist based at least on the travel time in response to the travel time being with the duration threshold and the at least one drive condition being satisfied; and
cause a sound to be emitted based on an audio signal indicative of a song from the playlist in an interactive mode using one or more speakers in the vehicle.

13. The system of claim 12, wherein to estimate the travel time of the vehicle, the one or more computing devices is further configured to:
obtain data indicative of a current travel state of at least one of the vehicle or the user; and
identify a potential destination of the user based on the current travel state and a travel destination predictor defined based on previous destinations traveled by the user, wherein the travel time is estimated based on the potential destination.

14. The system of claim 12, wherein the at least one drive condition includes at least one of a road condition, a traffic condition, or a weather condition.

15. The system of claim 14, wherein:
the at least one drive condition includes each of the road condition, the traffic condition, and the weather condition, and
each of the at least one drive condition is to be satisfied prior to providing the interactive mode.

16. The system of claim 12, wherein the one or more computing devices are further configured to:
monitor the travel time to a destination after defining the playlist; and
adjusting the playlist in response to the travel time changing.

17. The system of claim 12, wherein, for the interactive mode, the audio signal is indicative of instrumental portion of the song.

18. The system of claim 12, wherein:
the one or more computing devices are configured to detect and identify an occupant in the vehicle, wherein the identified occupant is the user, and
the playlist is defined based on a music preference profile associated with the user.

19. The system of claim 12, wherein the one or more computing devices are further configured to:
obtain a profile record associated with the user, wherein the profile record includes information related to a usage time when the interactive mode is employed,
wherein the playlist is further defined in response to a current time correlating with the usage time.

20. The system of claim 12, wherein, for the interactive mode, the one or more computing devices are further configured to:
provide the audio signal with a vocal portion of the song in response to receiving a vocal support request; and
provide the audio signal with instrumental portion of the song absent the vocal support request.
